(19) United States
(12) Patent Application Publication
(10) Pub. No.: US 2014/0099623 A1
(43) Pub. Date: Apr. 10, 2014

(54) SOCIAL GRAPHS BASED ON USER BIORESPONSE DATA

(71) Applicants: Karmarkar V. Amit, Palo Alto, CA (US); Richard R. Peters, Mill Valley, CA (US)

(72) Inventors: Karmarkar V. Amit, Palo Alto, CA (US); Richard R. Peters, Mill Valley, CA (US)

(21) Appl. No.: 13/644,426

(22) Filed: Oct. 4, 2012

(51) Int. Cl. G09B 7/00; G06F 17/30

(52) U.S. Cl. CPC G09B 7/00; G06F 17/30958
USPC 434/350; 707/798

(57) ABSTRACT

In one exemplary embodiment, a computer-implemented method of generating an implicit social graph is provided. The method can include the step of receiving a first eye-tracking data of a first user. The first eye-tracking data can be associated with a first component. The eye-tracking data can be received from a first user device. A second eye-tracking data can be received from a second user. The second eye-tracking data can be associated with a second visual component. The second eye-tracking data can be received from a second user device. One or more attributes can be associated with the first user. The one or more attributes can be determined based on an association of the first eye-tracking data and the first visual component. One or more attributes can be associated with the second user. The one or more attributes can be determined based on an association of the second eye-tracking data and the second visual component. The first user and the second user can be linked in an implicit social graph when the first user and the second user substantially share one or more attributes.

### CROSS-REFERENCE TO RELATED APPLICATIONS

This application is a continuation-in-part of and claims priority from U.S. application Ser. No. 13/076,346, titled METHOD AND SYSTEM OF GENERATING AN IMPLICIT SOCIAL GRAPH FROM BIORESPONSE DATA and filed Mar. 30, 2011. U.S. application Ser. No. 13/076,346 claims priority from provisional application No. 61/438,975, filed on Feb. 3, 2011. These applications are hereby incorporated by reference in their entirety.

### BACKGROUND

1. Field

This application relates generally to identifying social relationships with, inter alia, sensors, and more specifically to identifying social relationships from biological responses (bioresponse) to digital communications, digital elements, physical objects and other entities.

2. Related Art

Eye movements can include regressions, fixations, and/or saccades. A fixation can be when the eye gaze pauses in a certain position. A saccade can be when the eye gaze moves to another position. A series of fixations and saccades can define a scanpath. Information about a user's interest and/or state that is derived from the eye can be made available during a fixation and/or a saccadic pattern. For example, the locations of fixations along a scanpath can indicate what information loci on the stimulus were processed during an eye tracking session. On average, fixations last for around 200 milliseconds during the reading of linguistic text when the text is understood by the user. Periods of 350 milliseconds can be typical for viewing an image. Preparing a saccade towards a new goal takes around 200 milliseconds. If a user has a comprehension difficulty vis-à-vis a term the initial fixation vis-à-vis the term. can last for around 750 milliseconds. Longer fixations and/or regressions can indicate an interest in a term, object, entity and/or image (or even a component of the image). Other eye-behavior can be analyzed as well. For example, pupillary response may indicate interest in the subject of attention and/or indicate sexual stimulation (e.g. adjusting for modifications of ambient light). Scanpaths themselves can be analyzed as a user views a video and/or environment to determine user interest in various elements, objects, and/or entities therein.

Eye-tracking data and/or other bioresponse data can be collected from a variety of devices and sensors that are becoming more and more prevalent today. Laptops frequently include microphones and high-resolution cameras capable of monitoring a person's facial expressions, eye movements, or verbal responses while viewing or experiencing media. Cellular telephones now include high-resolution cameras, proximity sensors, accelerometers, touch-sensitive screens in addition to microphones and buttons, and these “smartphones” have the capacity to expand the hardware to include additional sensors. Moreover, high-resolution cameras are decreasing in cost making them prolific in a variety of applications ranging from user devices like laptops and cell phones to interactive advertisements in shopping malls that respond to mall patrons' proximity and facial expressions to user-wearable sensors and computers. The capacity to collect eye-tracking data and other bioresponse data from people interacting with digital devices is thus increasing.

### BRIEF DESCRIPTION OF THE DRAWINGS

The present application can be best understood by reference to the following description taken in conjunction with the accompanying figures, in which like parts may be referred to by like numerals.

FIG. 1 depicts a process of generating an implicit social graph from users' bioresponse data, according to some embodiments.

FIG. 2 illustrates a side vie of a pair of augmented-reality eyeglasses in an example embodiment.

FIG. 3 depicts an exemplary computing system configured to perform some of the processes described herein, according to an example embodiment.

FIG. 4 illustrates exemplary components and a exemplary process for detecting eye-tracking data.

FIG. 5 is a block diagram illustrating a system for creating and managing an implicit social graph and/or online social network, according to some embodiments.

FIG. 6 depicts an exemplary computing system configured to perform any one of the processes described herein

FIG. 7 illustrates an exemplary process for determining whether a user satisfied review parameters, according to some embodiments.

FIG. 8 illustrates an example graph depicting various relationships for values of time and bioresponse data, according to some embodiments.

FIG. 9 illustrates an example method of determining a user attribute, according to some embodiments.

FIG. 10 illustrates an example process of generating a social graph in an educational context, according to some embodiments.

### BRIEF SUMMARY OF THE INVENTION

In one embodiment, a computer-implemented method of generating an implicit social graph, the method comprising receiving a first eye-tracking data of a first user. The first eye-tracking data is associated with a first visual component. The eye-tracking data is received from a first user device. A second eye-tracking data is received from a second user. The second eye-tracking data is associated with a second visual component. The second eye-tracking data is received from a second user device. One or more attributes are associated with the first user. The one or more attributes are determined based on an association of the first eye-tracking data and the first visual component. One or more attributes are associated with the second user. The one or more attributes are determined based on an association of the second eye-tracking data and the second visual component. The first user and the second user are linked in an implicit social graph when the first user and the second user substantially share one or more attributes.

Optionally, a first non-eye-tracking bioresponse data may be measured for the first user. The first non-eye-tracking bioresponse data may be measured substantially contemporaneously with the first eye-tracking data. A second non-eye-tracking bioresponse data may be measured for the second user. The second non-eye-tracking bioresponse data may be measured substantially contemporaneously with the second eye-tracking data. A first user's pulse rate, respiratory rate or blood oxygen level may be optically detected. A weight value may be assigned to a link between a first node representing the first user and a second node representing the second user. The weight value may be based upon the first non-eye-tracking bioresponse data value and/or the second non-eye-tracking bioresponse data value.

In another embodiment, at least one educational object is presented to a set of students. A bioresponse data is obtained for each student vis-à-vis each educational object. An attribute of each student is determined based on the bioresponse data vis-à-vis the educational object and the educational object's attributes. Each attribute is scored based on the corresponding bioresponse data value. A social graph is created, wherein each student is linked according to substantially similar attributes.

In yet another embodiment, a dataset is obtained that describes a social graph. The social graph includes a first user and a second user. The first user and the second user are linked based on substantially common attributes determined from each user's bioresponse measurements vis-à-vis one or more entities. A link attribute in the dataset is set based on each user's bioresponse measurements vis-à-vis one or more entities. The link attribute links the first user's node with the second user's node in the social graph.

### DETAILED DESCRIPTION

Disclosed are a system, method, and article of manufacture of social graphs based on, inter alia, user bioresponse data. Although the present embodiments included have been described with reference to specific example embodiments, it can be evident that various modifications and changes may be made to these embodiments without departing from the broader spirit and scope of the particular example embodiment.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Exemplary Process

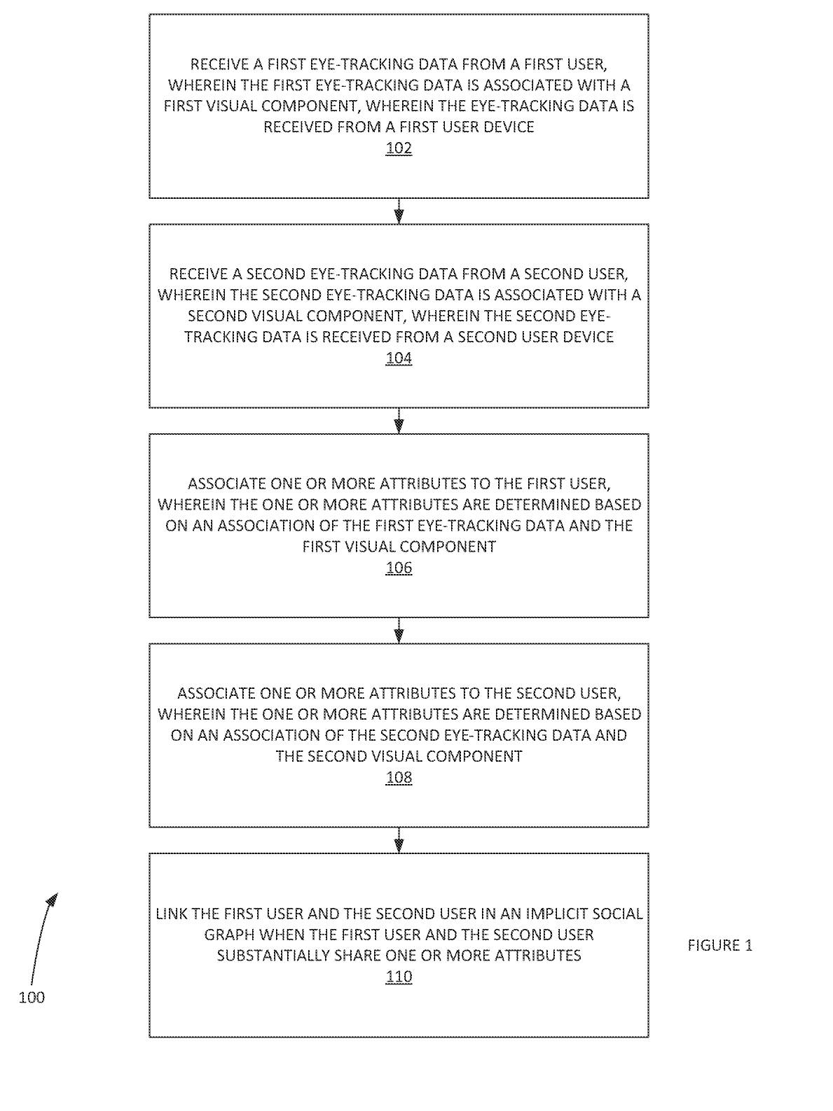

FIG. 1 depicts a process 100 of generating an implicit social graph from two or more users' bioresponse data, according to some embodiments. In step 102 of process 100, a first eye-tracking data from a first user can be received. The first eye-tracking data can be associated with a first visual component. The eye-tracking data can be received from a first user device. In step 104, a second eye-tracking data from a second user can be received. The second eye-tracking data can be associated with a second visual component. The second eye-tracking data can be received from a second user device. In step 106, one or more attributes can be associated with the first user. The one or more attributes can be determined based on an association of the first eye-tracking data and the first visual component. The first user's attributes can be derived, inter alia, from characteristics of the first visual component. In step 108, one or more attributes can be associated with the second user. The one or more attributes can be determined based on an association of the second eye-tracking data and the second visual component. The attributes can be derived, inter alia, from characteristics of the second visual component. In step 110, the first user and the second user can be linked in an implicit social graph when the first user and the second user substantially share one or more attributes. In one example embodiment, the link can be weighted according to the user's respective measured bioresponse values.

### Examplary Architectures and Systems

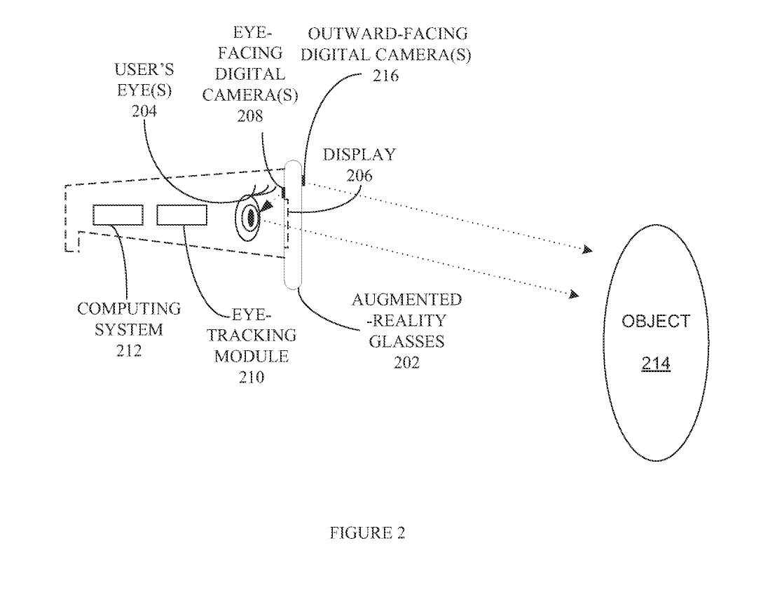

FIG. 2 illustrates a side view of a pair of augmented-reality eyeglasses 202, according to an example embodiment. Although this example embodiment is provided in an eyeglass format, it will be understood that wearable systems may take other forms, such as hats, goggles, masks, headbands and helmets. Augmented-reality glass 202 can include a head-mounted display (HMD). Extending side arms may be affixed to the lens frame. Extending side arms may be attached to a center frame support and lens frame. Each of the frame elements and the extending side-arm may be formed of a solid structure of plastic and/or metal, or may be formed of a hollow structure of similar material so as to allow wiring and component interconnects to be internally routed throughout the augmented-reality glasses 202.

A lens display may include lens elements that may be at least partially transparent so as to allow the wearer to look through lens elements. In particular, an eye 204 of the wearer may look through a lens that may include display 206. One or both lenses may include a display. Display 206 may be included in the augmented-reality glasses 202 optical systems. In one example, the optical systems may be positioned in front of the lenses, respectively. Augmented-reality glasses 202 may include various elements such as a computing system 212, user input device(s) such as a touchpad, a microphone, and/or a button(s). Augmented-reality glasses 202 may include and/or be communicatively coupled with other biosensors (e.g. with NFC, Bluetooth®, sensors that measure biological information about the user, etc.). The computing system 212 may manage the augmented reality operations, as well as digital image and video acquisition operations. Computing system 212 may include a client for interacting with a remote server (e.g. biosensor aggregation and mapping service) in order to send user bioresponse data (e.g. eye-tracking data, other biosensor data) and/or camera data and/or to receive information about aggregated bioresponse data (e.g. bioresponse maps, augmented-reality messages, and other data). For example, computing system 212 may use data from, among other sources, various sensors and cameras to determine a displayed image that may be displayed to the wearer. Computing system 212 may communicate with a network such as a cellular network, local area network and/or the Internet. Computing system 212 may support an operating system such as the Android™ and/or Linux operating system.

The optical systems may be attached to the augmented reality glasses 202 using support mounts. Furthermore, the optical systems may be integrated partially or completely into the lens elements. The wearer of augmented reality glasses 202 may simultaneously observe from display 206 a real-world image with an overlaid displayed image (e.g. an augmented-reality image). Augmented reality glasses 202 may also include eye-tracking system(s). Eye-tracking system(s) may include eye-tracking module 210 to manage eye-tracking operations, as well as, other hardware devices such as one or more a user-facing cameras and/or infrared light source(s). In one example, an infrared light source or sources integrated into the eye-tracking system may illuminate the eye(s) of the wearer, and a reflected infrared light may be collected with an infrared camera to track eye or eye-pupil movement.

Other user input devices, user output devices, wireless communication devices, sensors, and cameras may be reasonably included and/or communicatively coupled with augmented-reality glasses 202 (e.g. (user-facing and/or outward facing) heart-rate camera systems, breath-rate camera systems, body-temperature camera systems). In some embodiments, augmented-reality glass 202 may include a virtual retinal display (VRD).

Augmented reality glasses 202 can also include hardware and/or software systems for vision training (e.g. for sports vision training). For example, augmented reality glasses 202 can include strobe lights (e.g. a stroboscopic lamp) that produce regular flashes of light at various wavelengths (e.g. varying wavelengths, fixed wavelengths, fixed strobe periods, varying strobe period, etc.). In one example, augmented reality glasses 202 can be utilized as a stroboscope. For example, augmented reality glasses 202 can include a stroboscopic lamp that produces produce regular flashes of light at a wavelength not visible to a regular human eye (e.g. in the infrared spectrum). The stroboscopic lamp can be turned on based on user eye-tacking data and/or ambient environmental conditions, such as when a user is in a crowded room and/or user eye-tracking data indicates an interest in a particular person and/or object. User eye-tracking data(and/or other bioresponse data) can then be obtained from the user while the stroboscopic lamp is operating. Bioresponse data about the person/object of interest can also be obtained from images/video taken under stroboscopic conditions. For example, the person of interest's heart rate, temperature, respiratory rate can be determined from analysis of images/video of the person. This information can be provided to the user (e.g. via text message, email, an augmented-reality message and/or display provided by augmented reality glasses 202, etc.). Optionally, a camera sensor in augmented-reality glasses can be calibrated to ‘see’ the stroboscopic effect of the stroboscopic conditions based on the stroboscopic lamp's current wavelength. Augmented-reality glasses can translate these images into a user-viewable format and provide the images/video to the user in substantially real-time (e.g. via a GUI of a mobile device and/or an augmented-reality display, etc.) and/or be messaged to a user's account (e.g. via MMS, e-mail, and the like) for later review. In other embodiments, the ‘strobe-like’ effect can be implemented, not with a stroboscopic lamp(s), but by blocking most of the vision of either both eyes or one eye at a time (e.g. as with Nike's Vapor Strobe Eyewear®).

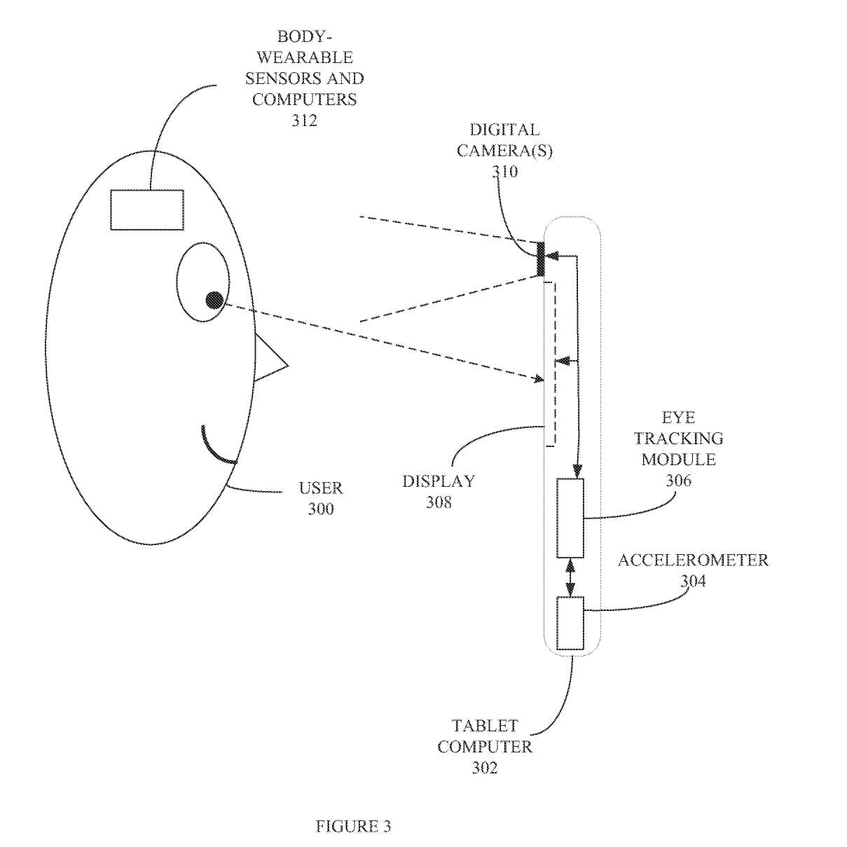

FIG. 3 illustrates one example of obtaining biosensor data from a user who is viewing a digital document presented by a computer display. In this embodiment, eye-tracking module 306 of tablet computer 302 tracks the gaze of user 300. Although illustrated here as a tablet computer 302 (such as an iPad®), the device may be a cellular telephone, personal digital assistant, laptop computer, body-wearable computer, augmented-reality glasses, other head-mounted display (HMD) systems, desktop computer, or the like. Additionally, although illustrated here as a digital document displayed by a tablet computer, other embodiments may obtain eye-tracking and other bioresponse data for other types of displays of a digital document (e.g. a digital billboard, augmented-reality displays, etc.) and/or physical objects and/or persons. Eye-tracking module 306 may utilize information from at least one digital camera 310 (may include infrared or other applicable light source) and/or an accelerometer 304 (or similar device that provides positional information of user device 300 such as a gyroscope) to track the user's gaze (e.g. broken lined arrow from eye of user 300). Eye-tracking module 306 may map eye-tracking data to information presented on display 308. For example, coordinates of display information may be obtained from a graphical user interface (GUI). Various eye-tracking algorithms and methodologies (such as those described herein) may be utilized to implement the example shown in FIG. 3.

In some embodiments, eye-tracking module 306 may utilize an eye-tracking method to acquire the eye movement pattern. In one embodiment, an example eye-tracking method may include an analytical gaze estimation algorithm that employs the estimation of the visual direction directly from selected eye features such as irises, eye corners, eyelids, or the like to compute a user gaze direction. If the positions of any two points of the nodal point, the fovea, the eyeball center or the pupil center may be estimated, the visual direction may be determined.

In addition, a light may be included on the front side of tablet computer 302 to assist detection of any points hidden in the eyeball. Moreover, the eyeball center may be estimated from other viewable facial features indirectly. In one embodiment, the method may model an eyeball as a sphere and hold the distances from the eyeball center to the two eye corners to be a known constant. For example, the distance may be fixed to 6 mm. The eye corners may be located (for example, by using a binocular stereo system and used to determine the eyeball center. In one exemplary embodiment, the iris boundaries may be modeled as circles in the image using a Hough transformation.

The center of the circular iris boundary may then be used as the pupil center. In other embodiments, a high-resolution camera and other image processing tools may be used to detect the pupil. It should be noted that, in some embodiments, eye-tracking module 306 may utilize one or more eye-tracking methods in combination. Other exemplary eye-tracking methods include: a 2D eye-tracking algorithm using a single camera and Purkinje image, a real-time eye-tracking algorithm with head movement compensation, a real-time implementation of a method to estimate user gaze direction using stereo vision, a free head motion remote eyes (REGT) technique, or the like. Additionally, any combination of any of these methods may be used.

Body wearable sensors and/or computers 312 may include any type of user-wearable biosensor and computer described herein. In a particular example, body wearable sensors and/or computers 312 may obtain additional bioresponse data from a user. This bioresponse data may be correlated with eye-tracking data. For example, eye-tracking tracking data may indicate a user was viewing an object and other bioresponse data may provide the user's heart rate, galvanic skin response values and the like during that period.

Various types of bioresponse sensors (body-wearable or otherwise) can be utilized to obtain the bioresponse data (e.g. digital imaging processes that provide information as to user's body temperature and/or heart rate, heat-rate monitors, body temperature sensors, GSR sensors, brain-computer interfaces such as an Emotiv®, a Neurosky BCI® and/or another electroencephalographic system, ascertaining a user's bioimpedance value, iris scanners, eye-tracking systems, pupil-dilation measurement systems, fingerprint scanners, other biometric sensors and the like).

Body-wearable sensors and/or other bioresponse sensors can be integrated into various elements of augmented-reality glasses 202. For example, sensors can be located into a nose bridge piece, lens frames and/or side arms.

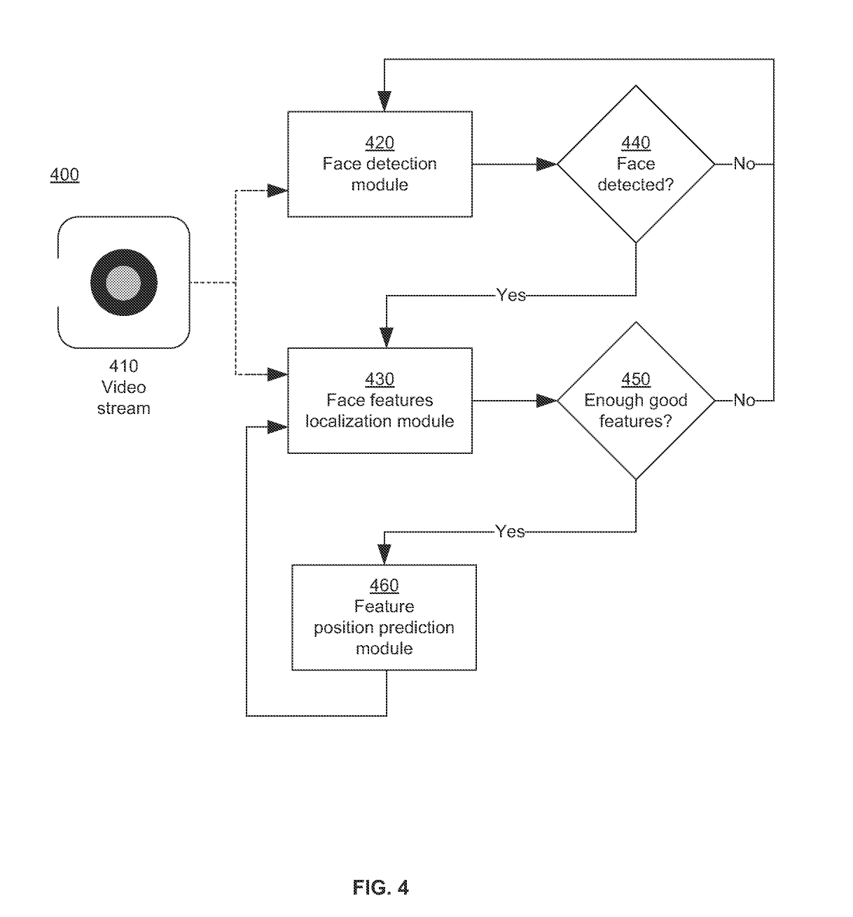

FIG. 4 illustrates exemplary components and an exemplary process 400 for detecting eye-tracking data. The gaze-tracking algorithm discussed above may be built upon three modules which interoperate to provide a fast and robust eyes- and face-tracking system. Data received from video stream 410 may be input into face detection module 420 and face feature localization module 430. Face detection module 420, at junction 440, may check whether a face is present in front of the camera, receiving video stream 410.

In the case that a face is present, face detection module 420 may determine a raw estimate of the 2D position in the image of the face and facial features (eyebrows, eyes, nostrils, and mouth) and provide the estimate to face features localization module 430. Face features localization module 430 may find the exact position of the features. When the feature positions are known, the 3D position and orientation of the face may be estimated. Gaze direction (e.g. user gaze of FIG. 3) may be processed by combining face orientation estimation and a raw estimate of eyeball orientation processed from the iris center position in the eyes.

If a face is not detected, control passes back to face detection module 420. If a face is detected but not enough facial features are detected to provide reliable data at junction 450, control similarly passes back to face detection module 420. Module 420 may try again after more data is received from video stream 410. Once enough good features have been detected at junction 450, control passes to feature position prediction module 460. Feature position prediction module 460 may process the position of each feature for the next frame. This estimate may be built using Kalman filtering on the 3D positions of each feature. The estimated 3D positions may then be back-projected to the 2D camera plane to predict the pixel positions of all the features. Then, these 2D positions may be sent to face features localization module 430 to help it process the next frame.

The eye-tracking method is not limited to this embodiment. Any eye-tracking method may be used. For example, it may consist of a high-sensitivity black and white camera (using, for example, a Sony EXView HAD CCD chip), equipped with a simple NIR filter letting only NIR wavelengths pass and a set of IR-LEDs to produce a corneal reflection on the users cornea. The IR-LEDs may be positioned below instead of beside the camera. This positioning avoids shadowing the opposite eye by the user's nose and thus supports the usage of reflections in both eyes. To test different distances between the camera and the user, the optical devices may be mounted on a rack. In some embodiments, only three of the nine IR-LEDs mounted on the rack are used, as they already provide sufficient light intensity to produce a reliably detectable reflection on the cornea. One example implementation of this embodiment uses the OpenCV library which is available for Windows™ and Linux platforms. Machine dependent parts may be encapsulated so that the program may be compiled and run on both systems.

When implemented using the OpenCV library, if no previous eye position from preceding frames is known, the input image may first be scanned for possible circles, using an appropriately adapted Hough algorithm. To speed up operation, an image of reduced size may be used in this step. In one embodiment, limiting the Hough parameters (for example, the radius) to a reasonable range provides additional speedup. Next, the detected candidates may be checked against further constraints like a suitable distance of the pupils and a realistic roll angle between them. If no matching pair of pupils is found, the image may be discarded. For successfully matched pairs of pupils, sub-images around the estimated pupil center may be extracted for further processing. Especially due to interlace effects, but also caused by other influences the pupil center coordinates, pupils found by the initial Hough algorithm may not be sufficiently accurate for further processing. For exact calculation of gaze 460 direction, however, this coordinate should be as accurate as possible.

One possible approach for obtaining a usable pupil center estimation is actually finding the center of the pupil in an image. However, the invention is not limited to this embodiment. In another embodiment, for example, pupil center estimation may be accomplished by finding the center of the iris, or the like. While the iris provides a larger structure and thus higher stability for the estimation, it is often partly covered by the eyelid and thus not entirely visible. Also, its outer bound does not always have a high contrast to the surrounding parts of the image. The pupil, however, may be easily spotted as the darkest region of the (sub-) image.

Using the center of the Hough-circle as a base, the surrounding dark pixels may be collected to form the pupil region. The center of gravity for all pupil pixels may be calculated and considered to be the exact eye position. This value may also form the starting point for the next cycle. If the eyelids are detected to be closed during this step, the image may be discarded. The radius of the iris may now be estimated by looking for its outer bound. This radius may later limit the search area for glints. An additional sub-image may be extracted from the eye image, centered on the pupil center and slightly larger than the iris. This image may be checked for the corneal reflection using a simple pattern matching approach. If no reflection is found, the image may be discarded. Otherwise, the optical eye center may be estimated and the gaze direction may be calculated. It may then be intersected with the monitor plane to calculate the estimated viewing point. These calculations may be done for both eyes independently. The estimated viewing point may then be used for further processing. For instance, the estimated viewing point may be reported to the window management system of a user's device as mouse or screen coordinates, thus providing a way to connect the eye-tracking method discussed herein to existing software.

A user's device may also include other eye-tracking methods and systems such as those included and/or implied in the descriptions of the various eye-tracking operations described herein. In one embodiment, the eye-tracking system may be a system as a Tobii® T60 XL eye tracker, Tobii® TX 300 eye tracker, augmented-reality glasses, Tobii® Glasses Eye Tracker, an eye-controlled computer, an embedded eye tracking system such as a Tobii® IS-1 Eye Tracker, Google® glasses, and/or other eye-tracking systems. The eye-tracking system may be communicatively coupled (e.g., with a USB cable, with a short-range Wi-Fi connection, or the like) with another local computing device (e.g. a tablet computer, a body-wearable computer, a smart phone, etc.). In other embodiments, eye-tracking systems may be integrated into the local computing device. For example, the eye-tracking system may be integrated as a user-facing camera with concomitant eye-tracking devices and/or utilities installed in a pair of augmented-reality glasses, a tablet computer and/or a smart phone.

In one embodiment, the specification of the user-facing camera may be varied according to the resolution needed to differentiate the elements of a displayed message. For example, the sampling rate of the user-facing camera may be increased to accommodate a smaller display. Additionally, in some embodiments, more than one user-facing camera (e.g., binocular tracking) may be integrated into the device to acquire more than one eye-tracking sample. The user device may include image processing utilities necessary to integrate the images acquired by the user-facing camera and then map the eye direction and motion to the screen coordinates of the graphic element on the display. In some embodiments, the user device may also include a utility for synchronization of gaze data with data from other sources, e.g., accelerometers, gyroscopes, or the like. In some embodiments, the eye-tracking method and system may include other devices to assist in eye-tracking operations. For example, the user device may include a user-facing infrared source that may be reflected from the eye and sensed by an optical sensor such as a user-facing camera.

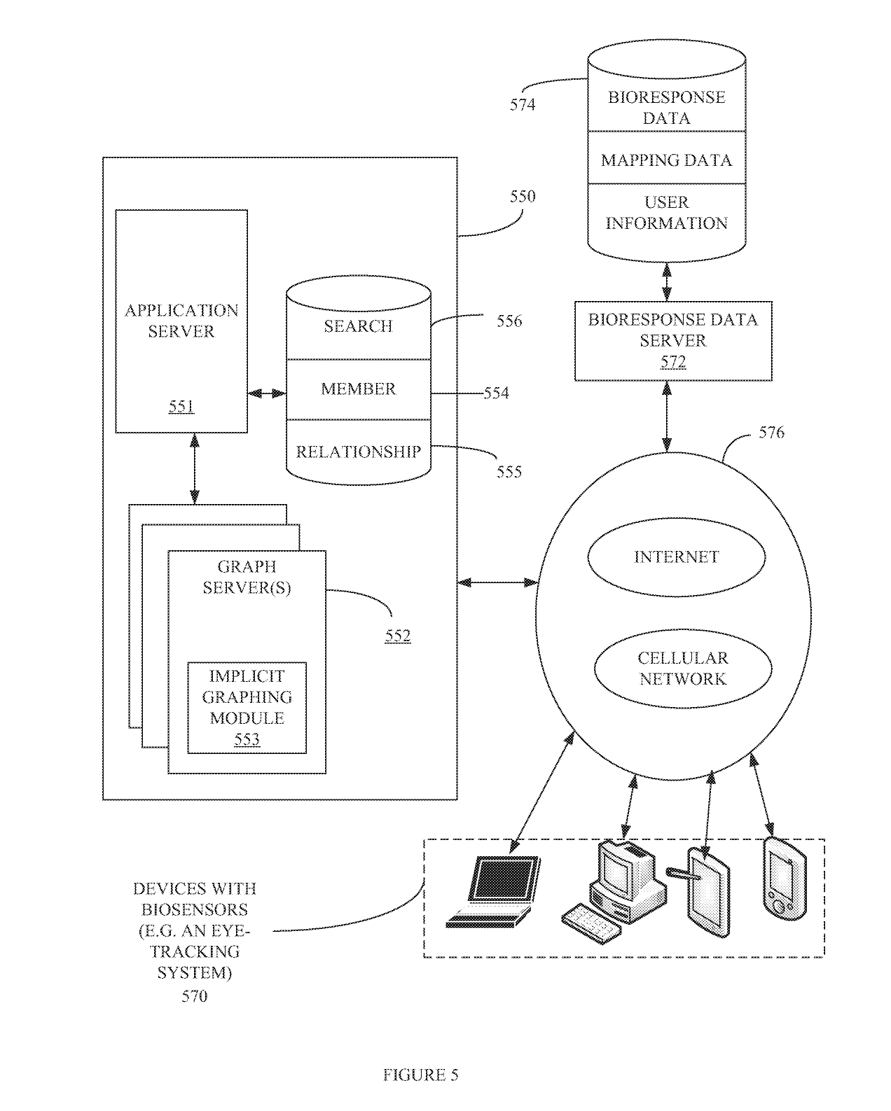

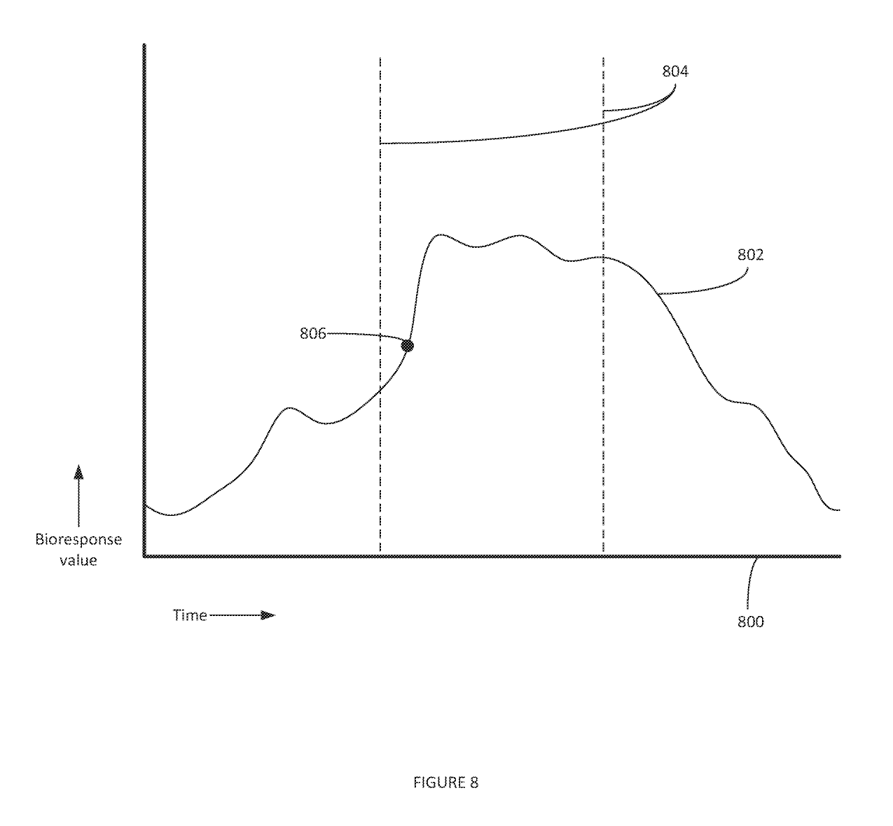

FIG. 5 is a block diagram illustrating a system for creating and managing a social graph (e.g. an implicit social graph) and/or online social network, according to some embodiments. As shown, FIG. 5 illustrates system 550 that includes an application server 551 and one or more graph servers 552. System 550 can be connected to one or more networks 560, e.g., the Internet, cellular networks, as well as other wireless networks, LANs, and the like. System 550 is accessible over the network by a plurality of computers, collectively designated as 570 (e.g. augmented-reality glasses 202, tablet computer 302, etc.). Application server 550 manages member database 554, relationship database 555, and search database 556. The member database 554 contains profile information for each of the members in one or more online social networks managed by the system 550. The profile information may include, among other things: a unique member identifier, name, age, gender, location, hometown, references to image files, listing of interests, attributes, and the like. The relationship database 555 stores information defining relationships between members (e.g. such as bioresponse edges, higher-order edges, etc.). In addition, the contents of the member database 554, search database 556 and/or relationship database 555 can be indexed and optimized for search, and stored in the search database 556. The member database 554, the relationship database 555, and the search database 556 can be updated to reflect inputs of new member information and edits of existing member information that are made through the computers 570. Search database 556 can be coupled with a social graph API that allows entities (e.g. third parties, web sites, etc.) to draw information about social graphs created and managed by the system 550. System 550 can include further modules for implementing any of the processes described herein (e.g. processes 100, 700, 900 and 1000; processes provided in the description of FIG. 8; implicit social graph processes described infra, as well as applicable processes described associated with FIGS. 2-5; and the like), according to various example embodiments.

The application server 551 also can manage the information exchange requests that it receives from the remote computers 570. The graph servers 552 can receive a query from the application server 551, process the query and return the query results to the application server 552. The graph servers 552 manage a representation of the social network for all the members in the member database. The graph servers 552 can include a dedicated memory device, such as a random access memory (RAM), in which an adjacency list that indicates all the relationships in the online social network and/or implicit social graph is stored. The graph servers 552 can respond to requests from application server 551 to identify relationships and the degree of separation between members of the online social network.

The graph servers 552 include an implicit graphing module 553. Implicit graphing module 553 obtains bioresponse data (such as eye-tracking data, hand-pressure, galvanic skin response, etc.) from a bioresponse module in devices 570 and/or bioresponse data server 572. For example, eye-tracking data of a text message viewing session can be obtained. along with other relevant information such as the identification of the sender and reader, time stamp, content of text message, data that maps the eye-tracking data with the text message elements, and the like. Implicit graphing module 553 can generate social graphs from data received by system 550 For example, implicit graphing module 553 can generate social graphs according to any method described herein. System 550 can receive information (e.g. bioresponse information) from client applications bioresponse modules) in user-side computing devices.

A bioresponse module (not shown) can be any module (e.g. a client-side module) in a computing device that can obtain a user's bioresponse to a specific component of a digital document such as a text message, email message, web page document, instant message, microblog post, and the like. A bioresponse module (and/or system 550) can include a parser that parses the digital document into separate components and indicates a coordinate of the component on a display of the device 570. The bioresponse module can then map the bioresponse to the digital document component that evoked the bioresponse. For example, this can be performed with eye-tracking data that determines which digital document component is the focus of a user's attention when a particular bioresponse was recorded by a biosensor(s) (e.g. an eye-tracking system) of the device 570. This data can be communicated to the implicit graphing module 553 and/or the bioresponse data server 572.

In some example embodiments, implicit graphing module 553 can use bioresponse and concomitant data such as digital document component data (as well as other data such as various sensor data) to determine an attribute of the user of the device 570 based on the attributes of objects/entities the user engages. An implicit social graph can be generated from the set of user attributes obtained from a plurality of users of the various devices communicatively coupled to the system 550. In some embodiments, the graph servers 552 use the implicit social graph to respond to requests from application server 551 to identify relationships and the degree of separation between members of the online social network as well as the type/strength of the relationship(s) between various users.

In some embodiments, implicit graphing module 553 can dynamically create one or more social graphs (e.g. implicit social graphs) from users' substantially current attributes. Bioresponse data server 572 can receive bioresponse and other relevant data (such mapping data that indicates the object/entity component associated with the bioresponse and user information) from the various client-side modules that collect and send bioresponse data, image data, location data, and the like. In some embodiments, bioresponse data server 572 can perform additional operations on the data such normalization and reformatting such that the data is compatible with system 550 and other social networking systems (not shown). For example, bioresponse data can be sent from a mobile device in the form of a concatenated SMS message. Bioresponse data server 572 can normalize the data and reformat into IP-protocol data packets and then forward the data to system 550 via the Internet. The datasets provided by FIG. 5 can be monetized through direct marketing and social commerce. It is noted that the functionalities of bioresponse data server 572 can be implemented in system 550 in some embodiments. Furthermore, in some example embodiments, the functionalities of bioresponse data server 572 can be implemented in system 550 can be implemented in a cloud-computing environment. In some embodiments, the systems of FIG. 5 can be utilized to manage the depiction of substantially real-time bioresponse data and/or social graph data with a mapping service platform. In one example, bioresponse data can be anonymized and individual bioresponse measurements depicted with a spatial mapping service (e.g. Google Maps®, with a Ushahidi platform, and the like). In another example, substantially similar types of bioresponse data can be summed and/or averaged for a geospatial region (e.g. a neighborhood, a city, about, a vehicle, a building, an office, a room, etc.). This data can be represented with a mapping service (e.g. as a heat map). In another example, user attributes can be topographically represented with a mapping service. These maps can be updated and modified in substantial realtime according to changes in values used to build the map. For example, a heat-map of a bioresponse data type and/or an interpretation of one or more bioresponse data types and/or a social graph can be updated to reflect substantially recent modifications measured bioresponse data for various users and/or changes in user location. Any map can be represented with data (e.g. user attributes, identified object/entity attributes, bioresponse data, social graphs, etc.) integrated (e.g. overlaid) into the mapping service map view. For example, the data can be depicted in various visual formats (e.g. fractal maps, tree maps, heat maps, etc.) and integrated (e.g. overlaid, tagged to relevant locations, etc.) into the mapping service map views. It is noted, that in some embodiments, user attributes, identified object/entity attributes, bioresponse data, social graphs data can be collected by a web service that provides an application programming interface for other entities (e.g. web mapping services) to query and obtain various portions of the dataset used to describe the user attributes, identified object/entity attributes, bioresponse data, social graphs. In one example, various bioresponse data can be measured and collected from users for an advertisement on a building. The building may be viewable in a street view of a mapping service. A view of the bioresponse data (e.g. as a tree map, pie chart, and/or any other method of representing data) can be provided to users of the mapping service when an icon associated with the street view of the building is ‘clicked’. In some embodiments, a user of a social graphing system can geotag object/entities with various information such as user identification information, social graph information, user-node information, bioresponse values measured vis-à-vis the object/entity, and the like. In other examples embodiments, asocial graph system can automatically geotag objects/entities based on various parameters (e.g. user bioresponse values vis-à-vis the object/entity, user settings, etc.). It is noted that a user may be geotagged well. A user's identity can be ascertainable by identifiable signals (e.g. the user's cellular phone's control signal, a Bluetooth device, an NFC and/or RFID device worn by the user, etc.) and/or image recognition algorithms (e.g. the user's image(s) can be included in a searchable database). Data such as the user attributes, identified object/entity attributes (e.g. that have been viewed by the user), bioresponse data (e.g. as measured by the user and/or that of other user's viewing the user), social graphs (e.g. that include the user as a user node), etc. that are associated with the user can be made available to other users (e.g. via a hyperlink to a web page with the information, via text message, email, and/or augmented reality displays, etc.). In one example, a user fixation of a specified time period can cause the viewed object to be associated with a geotag that includes user attributes (e.g. as determined vis-à-vis the viewed object), identified viewed object attributes, user bioresponse data vis-à-vis the viewed object, social graph attributed, etc. In some embodiments, tag clouds can be rendered that include tags that represent user attributes, identified object/entity attributes, bioresponse data, social graphs (e.g. a graphical representation of the social graph for a specified region), etc. These tag clouds can be made available in various formats such as datasets (e.g. via an API), text messaging services (e.g. MMS), images on web pages, email, etc. The various information can be arranged hierarchically in the tag cloud (e.g. objects with greater bioresponse values can be rendered larger and/or closer to the center of the tag cloud, more recently determined user attributes can be depicted in a specified color, etc.).

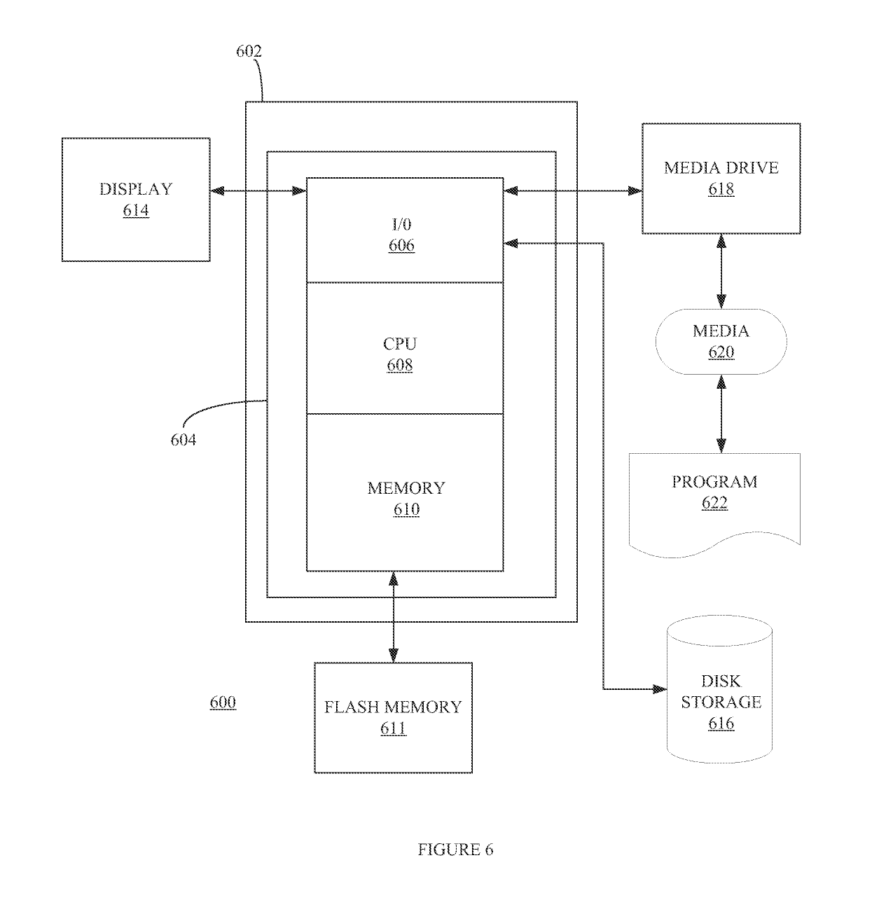

FIG. 6 depicts an exemplary computing system 600 that can be configured to perform any one of the processes provided herein. In this context, computing system 600 can include, for example, a processor, memory, storage, and I/O devices (e.g., monitor, keyboard, disk drive, Internet connection, etc.). However, computing system 600 can include circuitry or other specialized hardware for carrying out some or all aspects of the processes. In some operational settings, computing system 600 can be configured as a system that includes one or more units, each of which is configured to early out some aspects of the processes either in software, hardware, or some combination thereof.

FIG. 6 depicts a computing system 600 with a number of components that can be used to perform any of the processes described herein. The main system 602 includes a motherboard 604 having an I/O section 606, one or more central processing units (CPU) 608, and a memory section 610, which can have a flash memory card 612 related to it. The I/O section 606 can be connected to a display 614, a keyboard and/or other attendee input (not shown), a disk storage unit 616, and a media drive unit 618. The media drive unit 618 can read/write a computer-readable medium 620, which can include programs 622 and/or data. Computing system 600 can include a web browser. Moreover, it is noted that computing system 600 can be configured to include additional systems in order to fulfill various functionalities. Display 614 can include a touch-screen system and/or sensors for obtaining contact-patch attributes from a touch event. In some embodiments, system 600 can be included and/or be utilized by the various systems and/or methods described herein. In some embodiments, system 600 can include various sensors and/or eye-tracking systems.

Additional Disclosed Processes

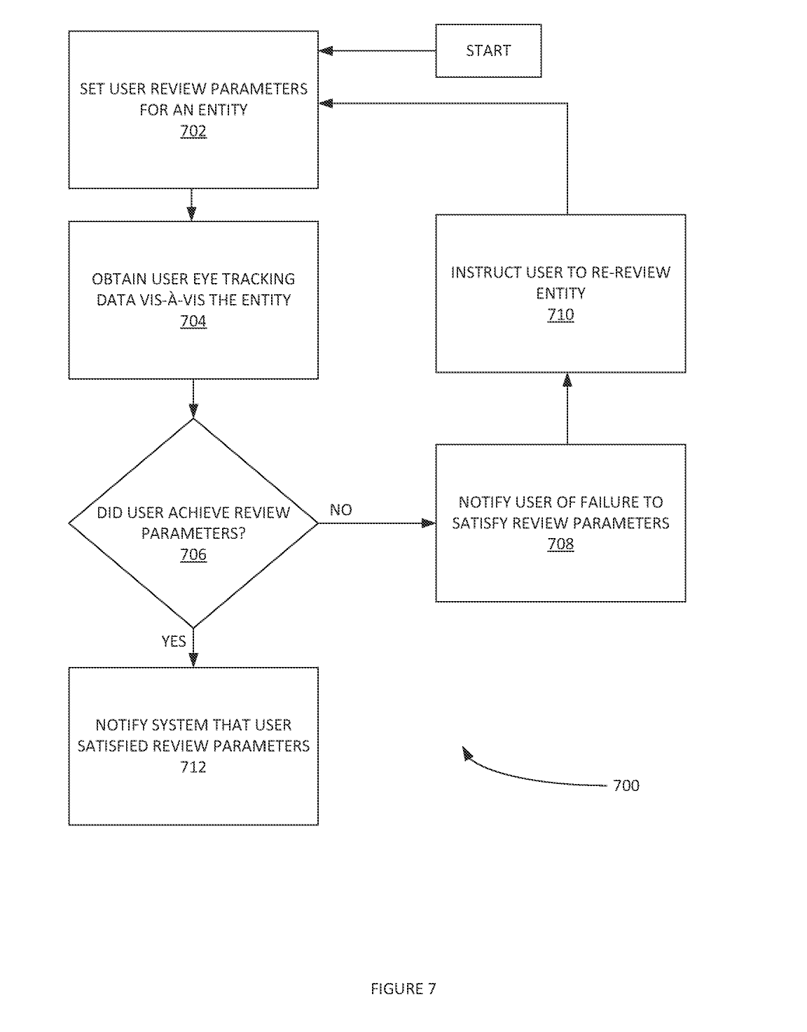

FIG. 7 illustrates an exemplary process 700 for determining whether a user satisfied review parameters, according to some embodiments. In step 702 of process 700, user review parameters are set for an entity. The user review parameters can include bioresponse data values. An entity can include an object to be reviewed. Example entities include labels (e.g. medical labels such a prescription bottle labels, etc.), charts (e.g. patient charts, medical records, digital documents, items for inspection (e.g. machinery, circuits, and the like), instructions, digital communications, written communications, etc.

A review parameter can include one or more user bioresponse values that can be measured by a bioresponse sensor e.g. an eye-tracking system). An example of a review parameter can include various eye-tracking metrics associated with a printed document. For example, a pharmacist can wear a pair of glasses with an outward facing camera and an eye-tracking system. The outward facing camera can be coupled with a computing system (e.g. a computing system in the glasses, a nearby computer coupled with the outward facing camera via a wireless technology, a remote server via the Internet, etc.). The computing system can include software and/or hardware systems that identify entities/objects in the pharmacist's view. The eye-tracking system can provide data that can be used to determine such behaviors as the period of time the pharmacist looked at a prescription bottle label, whether the pharmacist reviewed the entire label, etc. Thus, an example review parameter can include various actions such as whether a pharmacist read certain portions of a label and/or spend at least a certain time period (e.g. three seconds) reviewing the label. Other embodiments are not limited by this example.

It is noted that in some examples, entities can include review parameters embedded therein. For example, if the entity is printed on physical paper, the paper can be patterned paper (e.g. digital paper, interactive paper) that includes instructions that the outward-facing (with respect to the user) camera can read. These instructions can include the review parameters as well as other metadata. The user-wearable computing system can include appropriate systems for reading the patterned paper (e.g. an infra-red camera). The patterned paper can include other printed patterns uniquely that identify the position coordinates on the paper. These coordinates can be related to user eye-tracking behaviors to be satisfied (e.g. the user should read the text in a zone of the paper identified by a particular pattern; the user should look at a specified zone for two seconds, etc.).

In step 704, the user eye-tracking data is obtained vis-à-vis the entity. One or more bioresponse sensors, such as eye-tracking systems, can be integrated into a user-wearable computer and/or integrated into a computing system in the user's physical environment (e.g. integrated into a tablet computer, integrated into a user's work station, etc.). Various examples of biosensors are provided herein. The eye-tracking data can be communicated to one or more computing systems for analysis.

In step 706, it is determined whether a user's eye-tracing data achieved the review parameters. In one example, the entity can be an email message displayed with a computer display. It can be determined from eye-tracking data whether the user read the email. In another example, the entity can be a portion of a text book. It can be determined from eye-tracking data whether the user read the portion of the text book. If the eye-tracking data indicates that the review parameters were not achieved, then process 700 can proceed to step 708. In step 708, the user can be notified of his/her failure to satisfy the review parameters. Various notification options can be utilized including, inter alia, text messages, emails, augmented-reality messages, etc. The notification can be augmented with additional information such as information that describes the reason for the failure (e.g. did not review the patient's name, did not read the final paragraph, etc.) and/or modified instructions regarding fixture reviews of the entity. In step 710, the user may be instructed to review the object/entity. It is noted that some of the steps in process 700 can be optional and/or repeated a specified number of times. For example, in some embodiments, once a user has failed to satisfy the review parameters in step 706, process 700 can be terminated. It is further noted, that the review instructions can be dynamically updated by a system utilizing process 700. For example, the review instructions can be modified to increase the amount of time a user should review a particular section of a list. In another example, the review instructions can be modified to have a user to read a patient's profile a specified number of time (e.g. twice). The modifications can be based on a variety of factors such as an initial failure to satisfy the review instructions in steps 702-706, a user's substantially current bioresponse data profile (e.g. pulse rate and/or body temperature values and/or recent increases indicate a high-level of user stress, higher than normal levels ambient sounds and/or other data that can indicate a distractive environment, and the like).

If it is determined that a user's eye-tracking data achieved the review parameters in step 706, process 700 then proceeds to step 712. In step 712, the relevant system(s) can be notified that the user satisfied the review parameters. Information obtained from process 700 can be utilized to generate social graphs (e.g. implicit social graphs). For example, attributes from a first user regarding how the first user satisfied various review parameters can be used to generate a profile. Other similar profiles can be generated for other users relating to each user's relationship to various review parameters. These profiles can then be utilized to generate an implicit social graph. Location data can also be obtained from users and various aspects of the implicit social graph can be topographically represented (e.g. with a web mapping service and/or other application such as via a location-based social networking website for mobile devices).

Process 700 can also be utilized in an educational context. For example, review parameters can include reading and/or problem set assignments. Process 700 can be utilized to determine whether users adequately reviewed these assignments. Various bioresponse attributes of the user can be obtained while the user completes an assignment. These attributes can be stored in a database and utilized to generate an implicit social graph. If the implicit social graph includes more than one user, than education-related suggestions can be provided to a subgroup of users based, inter alia, on the implicit social graph. For example, a set of grammar flash cards can be advertised to a set of users linked together by a user-attribute that indicates certain grammar deficiencies. In another example, a hyperlink to an online lesson on introductory integration calculus can be sent (e.g. via email, text message, augmented-reality message, etc.) to a user with eye-tracking data that indicates a comprehension difficulty vis-à-vis an integral symbol. Thus, in some embodiments, the step of generating an implicit social graph may be skipped when providing suggestions to users.

In another example, an assignment to be graded can be assigned a review parameter for a grader to satisfy. For example, the assignment can be a legal bar exam essay answer and the review parameter can include whether the grader has read all the text of the completed essay (e.g. has not skipped any portion of the essay answer).

FIG. 8 illustrates an example graph 800 depicting various relationships for values of time and bioresponse data (and/or other types of available data), according to some embodiments. For example, at least one bioresponse data value 802 can be graphed as a function of time. It is noted that in other examples, two or more bioresponse data and/or other values (e.g. environmental data, location data, mobile device attributes such as accelerometer data, etc.) can be aggregated and/or otherwise represented in graph 800. It is further noted that bioresponse data value 802 can be offset based on other detected variables such as substantially current environment conditions as detected by sensors in a user's mobile device and/or other wearable computing device. FIG. 8 further depicts an example period 804 for which various types of data can be collected. Period 804 can be initiated based on a specified bioresponse data value(s) 802. For example, bioresponse data value 802 can represent a user's heart rate. A user's heart rate reaches ninety beats per minute or has a change of greater than twenty beats per minute in less than five seconds, and the like. These conditions can stored as an initiating value 806. In another example, bioresponse data value 802 can represent an aggregation of user's heart rate and a statistical analysis of the user's eye-tracking data (e.g. saccadic patterns, temporal magnitudes of fixations, number of regressions within a specified period). The statistical analysis of the user's eye-tracking data can be obtained fur user eye-tracking pattern vis-à-vis a particular object/entity for a time period corresponding to portion of the time axis of graph 800. Eye-tracking data for other objects/entities with a ‘low’ score (e.g. below a specified threshold value) can be filtered out. Thus, eye-tracking data can be scored vis-à-vis various objects in the user's view and these scores can be aggregated with other bioresponse data and/or used alone to generate bioresponse data 802. In one example, scored eye-tracking data associated with an object/entity with the highest score for a specified period may be utilized and objects/entities with lower eye-tracking data scores may be filtered out. Certain saccadic patterns may be associated with certain score values. Eye fixation values may be associated with certain score values. A number of regressions to the object/entity may be associated with certain score values. A pupil dilation rate of change may be associated with certain score values. Other eye-tracking phenomenon may be associated with certain score values.

More than one initiating value 806 can be stored in the system. Various initiating values 806 can be preset (and in some embodiments dynamically set by a remote server) for available biosensor and/or other mobile device sensor data (and/or combinations thereof). It is noted that various sensor data to be collected during period 804 can be continuously stored in a buffer memory. In this way, period 804 can be offset by a specified time interval in order to capture sensor data about an event that may have caused the change in the monitored bioresponse data value 802. Period 804 can be set to terminate based on various factors such as, inter alia, after a specified period of time, when a certain decrease in bioresponse value 802 has been measured, when the user's location has changed by a specified distance, and the like. Augmented-reality glasses 202 can include microphones and/or audio analysis systems. In one example, sounds with certain characteristics (e.g. police sirens, louder than average, a person yelling, a friend's voice, etc.) can be set as an initiating value 806.

Example types of sensor data that can be collected during period 804 can be selected to determine and/or obtain information about the cause the change in the bioresponse value. For example, a sensor can be an outward facing camera that records user views. The outward facing camera can obtain image/video data during period 804 and communicate the data to a system for analysis. Image recognition algorithms can be utilized to determine the identity of objects in the user's view preceding and/or during period 804. In this way, a list of candidate objects can be identity as to the cause of the change in the corresponding bioresponse data values 802. In another example, microphone data and audio recognition algorithms can also be used to obtain ambient and identify sounds in combination with the image/video data. Other environmental sensors and mobile device data sources can be utilized as well. For example, the signals of nearby mobile devices and Wi-Fi signals can be detected and identified. Various values of initiating value 806 can be provided for various combinations of bioresponse data values 802 and/or other data.

In some embodiments, various attributes (location, origin, color, state, available metadata, etc.) of the identified entities/objects that are identified during period 804 can be determined. For example, the object may be a digital image presented by an augmented-reality application and/or web page. Metadata (e.g. alt tags, file type, geotagging data, other data embedded in image, objects depicted in image, content of corresponding audio associated. image (e.g. with voice-to-text algorithms), and the like) can be parsed, identified and used to generate a list of attributes about the object. A means e.g. contextual, cultural, semantic and/or other meaning) of each object/entity attribute (and/or the object/entity as a whole) can be determined. These attributes and/or their corresponding meaning can then be algorithmically associated with the user in a specified manner based on the bioresponse type and values. In some embodiments, these associations can be utilized to generate an implicit social graph. It is noted that the magnitude of bioresponse value 802 (such as, inter alia, during period 804) can be used to assign a weight(s) to the links between nodes of the implicit social graph.

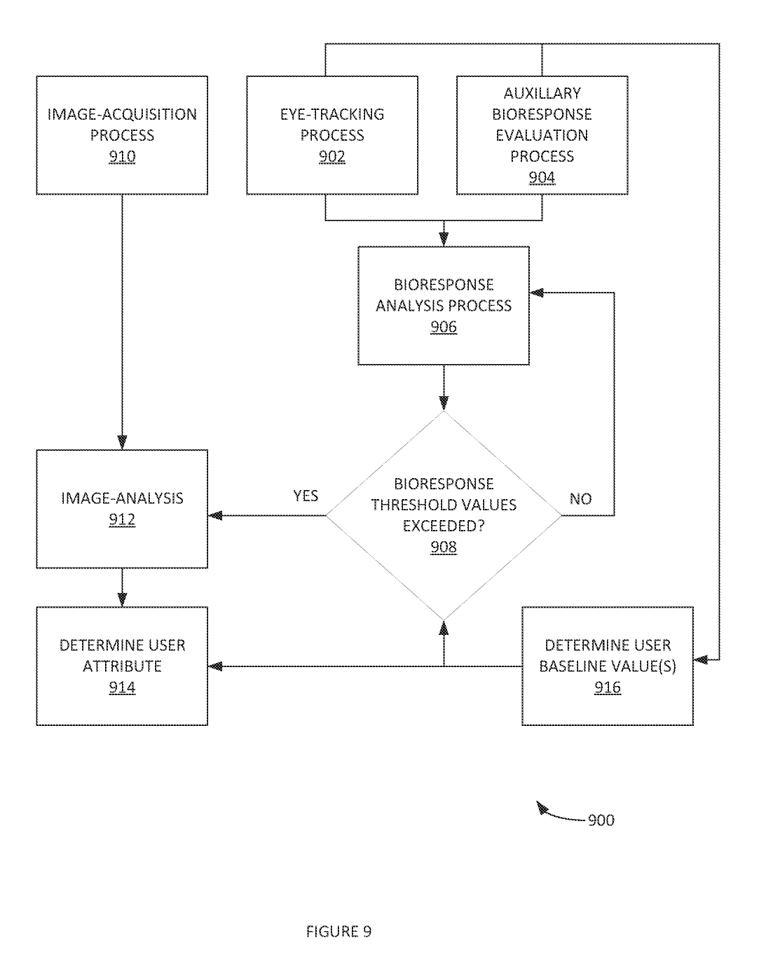

FIG. 9 illustrates an example method 900 of determining a user attribute, according to some embodiments. In step 902 of process 900, an eye-tracking process is monitored. User eye-tracking data can be stored in a data buffer that is accessible by a bioresponse analysis process 906. In step 904 of process 900, an auxiliary bioresponse process evaluation process is monitored. User auxiliary bioresponse data can be stored in a data buffer that is accessible by a bioresponse analysis process 906. Auxiliary bioresponse data can include data from biosensors that provide information about a user. In step 906, the data from processes 902 and 904 are monitored, normalized and/or analyzed (e.g. see the description of FIG. 8 as a particular example). Values can be assigned to various user eye-tracking behavior and/or auxiliary bioresponse data. Various parameter values can be associated with different types of eye-tracking behaviors and/or auxiliary bioresponse data. In some examples, the parameter values can be dynamically varied based on user settings, environmental conditions, power saving settings, and the like. In step 908, it is determined if an eye-tracking behaviors and/or auxiliary bioresponse data has exceeded a specified parameter. For example, a user may have fixated his gaze on an object for greater than three seconds and/or a user's heart rate may have increased by twenty-beats-per-minutes less than fifteen seconds, etc. If step 908 is resolved to ‘no’, process 900 returns to step 906. If step 908 resolves to ‘yes’, then process 900 proceeds to step 912. It is noted however, that each user can be associated with certain baseline eye-tracking behaviors and/or auxiliary bioresponse data values. For example, a user's age can be used to adjust various threshold parameters used in step 908. A user with an historical low heart-rate average can have his heart-rate rate of change threshold value decreased, for example. A user with historically longer-than-average gaze fixations (e.g. as compared with a general anthropological and/or other demographic group average) can have his gaze fixation threshold time increased based on the difference between his historical gaze fixation average and his demographic group average, for example. It is noted that in sonic examples, a score can be assigned to particular periods of eye-tracking data and/or auxiliary bioresponse data based on the data's maximum and/or average value for that period.

In step 910, an image-acquisition process is monitored. For example, a pair of eye-tracking goggles can include one or more outward facing cameras. These cameras can provide data to an image buffer. In step 912, this data can be parsed and analyzed when an instruction is received from step 908. For example, if the image is part of a digital document, then metadata about the image and/or document (e.g. alt tag, image recognition algorithms can be used to identify image and/or its components, metadata about image files, metadata about nearby audio, video, and other files, nearby developer comments, html tags, digital document origin information, other image attributes such as color, size, etc.) can be collected. This information can be analyzed to determine a meaning of the image based on the image's characteristics, context and elements. Meaning can also be implied from comparing user profile information and/or demographic data with the image's characteristics, context and elements. For example, the user may be a heterosexual married man that has viewed a pair of women's hiking boots on a hiking store website. An attribute of ‘man buying hiking boots for wife’ can be assigned to the user in step 914 as step 914 determines a user attribute. Based on the values of the eye-tracking data and/or auxiliary bioresponse data, this attribute can receive a score. This score can be used to assign weights to various edges that may be formed between the user's node and other user nodes in a social graph. It is noted that in some example embodiments, process 900 can be modified to include sounds and other environmental information to be utilized in lieu or and/or in addition to image data.

In some embodiments, the implicit social graph can be rendered as a dataset such as an implicit social network dataset, an interest graph dataset, a dataset to perform process 100, 700, 900, 1000, and/or any other process described herein, etc. (e.g. by the implicit graphing module 553). It is noted that members (e.g. a user node) can be linked by common attributes as ascertained from bioresponses and related data (e.g. attributes of the object/entity associated with the bioresponses). Links can be weighted according to information obtained about the attributes. An edge weight can be calculated according to various factors such as a cumulative value of bioresponse scores between two users, average value of bioresponse scores between two users, and/or other statistical methods. In some embodiments, links can be dyadic. The weight of an edge that signifies the relationship can be evaluated on the basis of a variety of parameters such based each node's bioresponse values vis-à-vis a type of object/entity, each node's bioresponse values vis-à-vis a type of object/entity as a function of time, demographic attributes, object/entity attributes, types of bioresponse data utilized, information obtained from other social networks (e.g. whether the users of each node know each other), etc. Thus, in some embodiments, a dyad can be dynamically updated according to the passage of time and/or acquisition of new relevant data In other embodiments, dyads can be fixed once created and saved as snapshots with timestamp data.

In one example, the eye-tracking data and/or other bioresponse data values can be used to assign a weight a link between two user nodes. For example, eye-tracking data can indicate a strong interest for two users in a particular image of a product (e.g. has substantially matching fixation periods, number of regressions and/or saccadic patterns). Eye-tracking data can indicate a moderate interest on the part of a third user in the particular product (e.g. a short fixation period than the other two users). All three users can be linked by an edge with an attribute indicating interest in the particular image of the product. However, the edge between the first two users can have a greater weight (e.g. scored according to the previously obtained eye-tracking data) than the edge between the first and the third user and the edge between the second and the third user.

It is noted that edge weights can decrease for a variety of factors. For example, edge weight can be set to decrease as a function of time. Another factor that can be used to modify (e.g. increase or decrease) an edge weight is information about a more recent bioresponse event vis-à-vis a similar and/or substantially identical object/entity. For example, taking the previous example, the first user can view another advertisement for the product. The user's heart rate may increase and eye-tracking (and/or other bioresponse data) may indicate that the user is still interested or even more interested in the product. Thus, the user's attribute relating to interest in the product can be scored higher. Thus, the weight of the edge between the node of the first and second user can be increased (e.g. based on a score derived from the eye-tracking (and/or other bioresponse data)). Alternatively, the second user can later view the product advertise and eye-tracking (and/or other bioresponse data) can indicate a decreased interest in the product. Several options for modifying the edge's weight can be made available, such as defining the edge's weight as an average of the attribute scores (e.g. as adjusted by latest or historically averaged eye-tracking (and/or other bioresponse data) values vis-à-vis the product's advertisement), the edge can be removed as the second user is displaying a decreased interest, the edge can be replaced with two edges where each user node's attribute value is represented by a unidirectional edge and the edge's weight is based on a rate of change for said attribute value, etc.

In some embodiments, the rate of decrease of an edge weight and/or a user's attribute score can be based on various factors such as the type of bioresponse data used (edges based on interest indicated by eye-tracking data can decrease slower than edges based on higher than normal heart rate data), prior relationships between users (e.g. users with a certain number of prior or extant relationships based on other types of bioresponse data can have a slower rate of edge decay), reliability of bioresponse data (e.g. in one embodiment, edges based on eye-tracking data can be scored higher and/or decay slower than edges based on galvanic skin response data).

Moreover, once detected, an edge may be set to increase as a function of time as well. In this way, the lifetime of an edge can follow a substantially bell-shaped curve as a function of time with the peak of the curve representing a maximum measured bioresponse value of the event that generated the edge.

Higher-order edges can also be generated between user nodes. A higher-order edge can include attributes that indicate metadata about other bioresponse-based edges. For example, if two nodes have five bioresponse-based edges formed between them in a month period, a higher-order edge indicating this information can be generated between the two edges. The higher-order edge may or may not be set modified as a function of time. In one example, a ‘total edge count’ edge can be maintained that counts the historical total edges between user nodes. Types of total edge counts can also be designed based on other edge or user attributes such as type of bioresponse data, user attributes, types of objects/entities associated with bioresponse data, etc. For example, a ‘total eye-tracking data indicates interest in Brand X wine’ edge can be created between two user nodes. The weight of the edge can increase each time a new edge is created. Another type of higher-order edge can include a ‘current edge count’ edge that is weighted according to current total edges between users. Another type of higher-order edge can include a ‘current edge weight’ edge that is weighted according to current total edge weight between users. A higher-order edge can be generated that indicates historical maximums and/or minimums of various types of bioresponse-based edges and/or higher-order edges between user nodes. For example, a ‘historical maximum edge weight for Wine interest as indicated by eye-tacking data edge’ can be provided between two relevant user nodes.

It is noted that bioresponse data can be used to also determine a user-attribute change (e.g. a user may learn the meaning of a term that he not once comprehend, a user may become a fan of a sport's team, a user may view but not indicate interest in an advertisement and/or product, etc.). In the event that user-attribute change indicates that a current edge is now obsolete, the edge can be removed. However, a historical higher-order edge's status can still be maintained in some examples. For example, bioresponse data can have indicated a user interest in a type of product. The user may have recently passed by images for the product on a web page several times without eye-tracking data that indicates a current sufficient interest (e.g. didn't view product image for a sufficient period of time some rate of exposure such as four times in three days). This information can be used to modify the attributes of the user nodes interest list (e.g. remove or diminish the score of the user's interest in the product). Consequently, any existing edges between the user and other users with a similar interest in the product can be removed and/or receive a diminished weight.

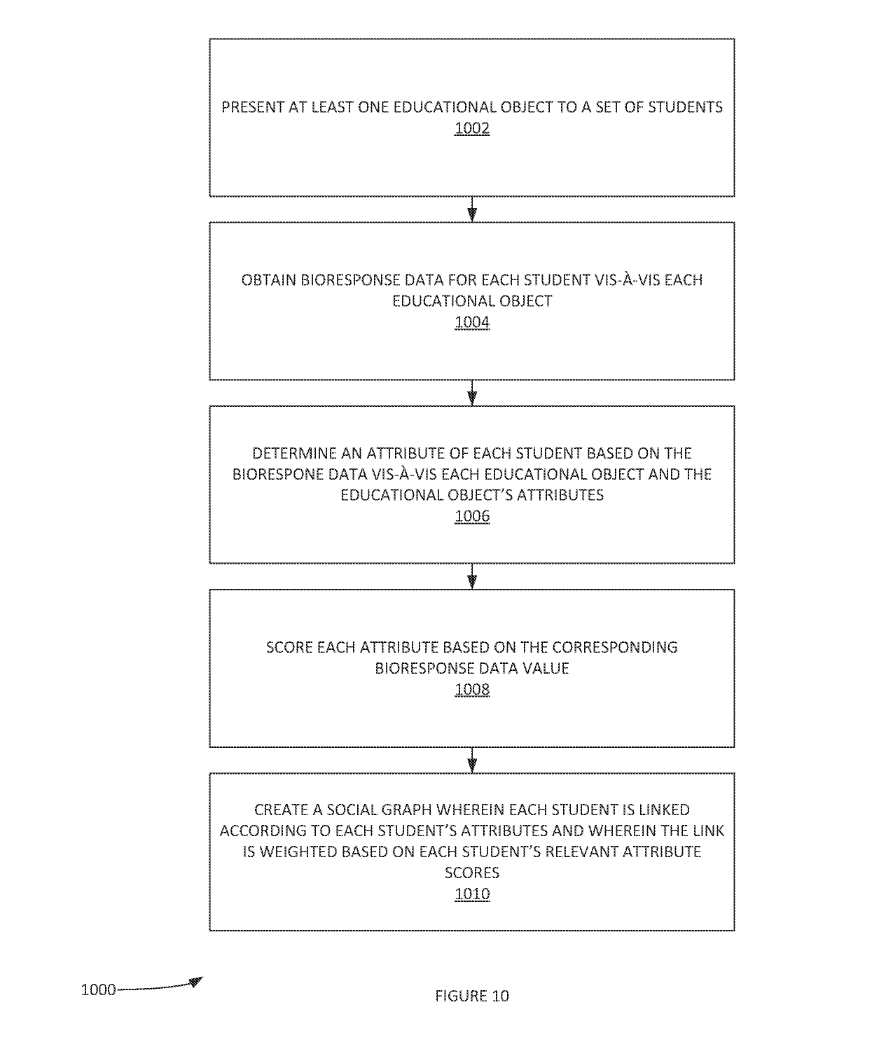

FIG. 10 illustrates an example process 1000 of creating asocial graph of a set of users in an educational context, according to some embodiments. In step 1002, at least one educational object (e.g. a portion of text, a vocabulary term, a musical score, an image of a historical figure, a math equation, a foreign language term, a dictionary definition, a playing of a an audio file of a historically significant speech, a text question, a film, etc.) is presented to a set of students. In step 1004, a bioresponse data (e.g. eye-tracking data, bioresponse data that indicates stress levels, and the like) is obtained from. each student vis-à-vis each educational object. In step 1006, an attribute of each student is determined based on the bioresponse data vis-à-vis the educational object(s). Attributes can be determined based on the content of the educational object and/or its particular elements and characteristics. In step 1008, each attribute is scored based on the corresponding student bioresponse data values. For example, a student with eye-tracking data that indicates a comprehension difficulty vis-à-vis a term can receive a negative one point, while another student with eye-tracking data that indicates comprehension vis-à-vis the term can receive a positive one point. Other attribute scoring systems are not limited by this particular example.

Other substantially cotemporaneous bioresponse values can also be utilized to implement a score. For example, the other student can have a substantially average heart rate (e.g. based on the student's historical average heart rate and/or demographic norms) while engaging the educational object. Thus, the student's relevant attribute score can receive another point. Whereas, the student with the eye-tracking data that indicates a comprehension difficulty vis-à-vis a term can also have other bioresponse data measurements that indicate a higher than normal level of anxiety (e.g.. based on the student's historical average bioresponse data and/or demographic norms). This student's relevant attribute score can receive another negative point. Other attribute scoring systems are not limited by this particular example.

In step 1010, a social graph can be created. Each student can be linked according the student's particular attributes vis-à-vis the various educational objects. For example, each student can be represented as a node in a social graph. Each node can include the student's attributes and corresponding attribute scores. In one example, students' with common attributes can be linked. In another example, a minimum attribute score for each node may be required to be achieved before a link is generated. Links can be weighted. Weight values can be determined according to a variety of methods and can include such factors as the student node's relevant attribute scores, student profile data, educational object attributes, etc. In some embodiments, links and link weights can be updated and/or modified dynamically based on substantially current student bioresponse data vis-à-vis educational objects experienced in substantially real time.

At least some values based on the results of the above-described processes can be saved for subsequent use. Additionally, a computer-readable medium can be used to store (e.g., tangibly embody) one or more computer programs thr performing any one of the above-described processes by means of a computer. The computer program may be written, for example, in a general-purpose programming language (e.g., Pascal, C, C++, Java, Python, etc.) and/or some specialized application-specific language (PHP, Java Script, XML, etc.).

### CONCLUSION

Although the present embodiments have been described with reference to specific example embodiments, various modifications and changes can be made to these embodiments without departing from the broader spirit and scope of the various embodiments. For example, the various devices, modules, etc, described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium. Finally, acts in accordance with FIGS. 1-10 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

What is claimed as new and desired to be protected by Letters Patent of the United States is:

1. A computer-implemented method of generating an implicit social graph, the method comprising:
receiving a first eye-tracking data of a first user, wherein the first eye-tracking data is associated with a first visual component, wherein the eye-tracking data is received from a first user device;
receiving a second eye-tracking data of a second user, wherein the second eye-tracking data is associated with a second visual component, wherein the second eye-tracking data is received from a second user device;
associating one or more attributes to the first user, wherein the one or more attributes are determined based on an association of the first eye-tracking data and the first visual component;
associating one or more attributes to the second user, wherein the one or more attributes are determined based on an association of the second eye-tracking data and the second visual component; and
linking the first user and the second user in an implicit social graph when the first user and the second user substantially share one or more attributes.

2. The computer-implemented method of claim 1 further comprising:
measuring a first non-eye-tracking bioresponse data for the first user, wherein the first non-eye-tracking bioresponse data is measured substantially contemporaneously with the first eye-tracking data.

3. The computer-implemented method of claim 2 further comprising:
measuring a second non-eye-tracking bioresponse data for the second user, wherein the second non-eye-tracking bioresponse data is measured substantially contemporaneously with the second eye-tracking data.

4. The computer-implemented method of claim 3, wherein the one or more attributes of the first user are determined based on an association of the first eye-tracking data and the first visual component when the first non-eye-tracking bioresponse data value exceeds a specified threshold value.

5. The computer-implemented method of claim 4, wherein the one or more attributes of the second user are determined based on an association of the second eye-tracking data and the second visual component when the second non-eye-tracking bioresponse data value exceeds a specified threshold value.

6. The computer-implemented method of claim 5, wherein measuring the first non-eye-tracking bioresponse data from the first user comprises:
optically detecting a first user's pulse rate, respiratory rate or blood oxygen level.

7. The computer-implemented method of claim 6, wherein measuring the second non-eye-tracking bioresponse data from the first user comprises:
optically detecting a second user's pulse rate, respiratory rate or blood oxygen level.

8. The computer-implemented method of claim 1, wherein first eye-tracking data and is measured by an eye-tracking system in user-wearable computing system worn by the first user.

9. The computer-implemented method of claim 1
assigning a weight value to a link between a first node representing the first user and a second node representing the second user, and wherein the weight value is based upon the first non-eye-tracking bioresponse data value and the second non-eye-tracking bioresponse data value.

10. A computer-implemented method comprising:
presenting at least one educational object to a set of students;
obtaining a bioresponse data for each student vis-à-vis each educational object;
determining an attribute of each student based on the bioresponse data vis-à-vis the educational object and the educational object's attributes;
scoring each student attribute based on the corresponding bioresponse data value; and
creating a social graph, wherein each student is linked according to substantially similiar attributes.

11. The computer-implemented method of claim 11, wherein a link between two students is weighted based on the two students common attribute scores.

12. The computer-implemented method of claim 11, wherein the bioresponse data is obtained from an eye-tracking system.

13. The computer-implemented method of claim 12, wherein the eye-tracking system is integrated into a pair of glasses.

14. The computer-implemented method of claim 13, wherein the pair of glasses comprises an outward-facing camera that obtains an image used to identify the educational object.

15. The computer-implemented method of claim 14, wherein the outward-facing camera that obtains an image used to identify an educational object's attribute.

16. A computer-implemented method comprising:
obtaining a dataset that describes a social graph, wherein the social graph comprises a. first user and a second user, and wherein the first user and the second user are linked based on substantially common attributes determined from each user's bioresponse measurements vis-à-vis one or more entities; and
setting a link attribute in the dataset based on each user's bioresponse measurements vis-à-vis one or more entities, wherein the link connects a first user's node and a second user's node in the social graph.

17. The computer-implemented method of claim 6 further comprising:
receiving a first updated bioresponse measurement of the first user; and
updating the link attribute in the dataset based on the first updated bioresponse measurement.

18. The computer-implemented method of claim 17 further comprising:
receiving a first updated bioresponse measurement of the first user; and
updating the link attribute in the dataset based on the first updated bioresponse measure.

19. The computer-implemented method of claim 18, wherein a bioresponse measurement is obtained from an eye-tracking system.

20. The computer-implemented method of claim 19, wherein a first user attribute is derived from an entity attribute when a specified bioresponse measurement obtains a specified value while the first user is viewing the entity as indicated by a first user's gaze.
